(19) United States
(12) Patent Application Publication
(10) Pub. No.: US 2026/0003619 A1
(43) Pub. Date: Jan. 1, 2026

(54) Per-Thread Stop-The-World Management for Garbage Collection

(71) Applicant: International Business Machines Corporation, Armonk, NY (US)

(72) Inventors: Michihiro Horie, Ageo City (JP); Kazunori Ogata, Soka-shi (JP)

(21) Appl. No.: 18/756,353

(22) Filed: Jun. 27, 2024

(51) Int. Cl. G06F 9/30; G06F 8/41

(52) U.S. Cl. CPC G06F 9/30047; G06F 8/457; G06F 9/3009

(57) ABSTRACT

Managing per-thread stop-the-world garbage collection is provided. A set of threads of a plurality of threads is transitioned from a normal thread state to a no-read-no-write thread state at a first safepoint of a pair of contiguous safepoints using a first set of thread transition code inserted in program code of an application at the first safepoint. Execution of any remaining threads of the plurality of threads having a normal thread state is suspended at the first safepoint. Stop-the-world garbage collection of a memory heap dedicated to the application is performed while allowing the set of threads of the plurality of threads having the no-read-no-write thread state to continue execution in a region within the program code between the pair of contiguous safepoints based on a special status tag of the first safepoint of the pair of contiguous safepoints.

### BACKGROUND

The disclosure relates generally to garbage collection and more specifically to managing garbage collection.

When an application runs, the application creates objects on a memory heap, which is a portion of main memory dedicated to the application. Eventually, the application will no longer reference some objects in the memory heap. A referenced object or an in-use object means that some part of the application still maintains a pointer to that object in the memory heap. An unreferenced or unused object is no longer referenced by any part of the application. A garbage collector automatically finds these unreferenced or unused objects and deletes these objects from the memory heap to free up memory space. In other words, the garbage collector automatically reclaims memory that is storing unreferenced objects. Thus, garbage collection relieves a programmer from performing manual memory management, where the programmer specifies what objects to delete and when to do so.

### SUMMARY

According to one illustrative embodiment, a computer-implemented method for managing per-thread stop-the-world garbage collection is provided. A computer, using a first set of thread transition code inserted in program code of an application at a first safepoint of a pair of contiguous safepoints, transitions a set of threads of a plurality of threads from a normal thread state to a no-read-no-write thread state at the first safepoint. The computer suspends execution of any remaining threads of the plurality of threads having a normal thread state at the first safepoint of the pair of contiguous safepoints inserted within the program code of the application. The computer, using a garbage collector, performs stop-the-world garbage collection of a memory heap dedicated to the application while allowing the set of threads of the plurality of threads having the no-read-no-write thread state to continue execution in a region within the program code between the pair of contiguous safepoints based on a special status tag of the first safepoint of the pair of contiguous safepoints. According to other illustrative embodiments, a computer system and computer program product for managing per-thread stop-the-world garbage collection are provided.

### BRIEF DESCRIPTION OF THE DRAWINGS

FIG. 1 is a pictorial representation of a computing environment in which

illustrative embodiments may be implemented;

FIG. 2 is a diagram illustrating an example of a safepoint insertion process in accordance with an illustrative embodiment;

FIG. 3 is a diagram illustrating an example of a per-thread stop-the-world garbage collection management process in accordance with an illustrative embodiment;

FIGS. 4A-4B are a flowchart illustrating a process for statically compiling application program code in accordance with an illustrative embodiment; and

FIGS. 5A-5B are a flowchart illustrating a process for managing per-thread stop-the-world garbage collection in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

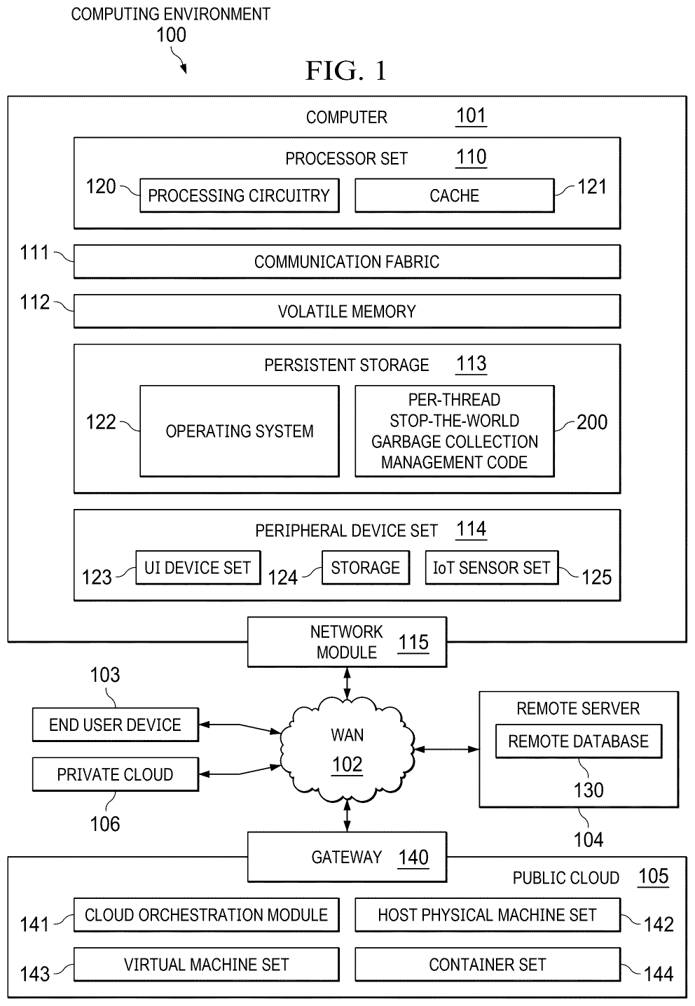

With reference now to the figures, and in particular, with reference to FIG. 1, a diagram of a data processing environment is provided in which illustrative embodiments may be implemented. It should be appreciated that FIG. 1 is only meant as an example and is not intended to assert or imply any limitation with regard to the environments in which different embodiments may be implemented. Many modifications to the depicted environment may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as per-thread stop-the-world garbage collection management code 200. For example, per-thread stop-the-world garbage collection management code 200 allows application threads that do not perform a read or a write of objects within a memory heap dedicated to the application to continue to run at the stop-the-world phase of garbage collection to increase performance.

In addition to per-thread stop-the-world garbage collection management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and per-thread stop-the-world garbage collection management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in per-thread stop-the-world garbage collection management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system developer who utilizes the per-thread stop-the-world garbage collection management services provided by computer 101), and may take any of the forms discussed above in connection with computer 101. EUD 103 typically receives helpful and useful data from the operations of computer 101. For example, in a hypothetical case where computer 101 is designed to provide a per-thread stop-the-world garbage collection management recommendation to the end user, this recommendation would typically be communicated from network module 115 of computer 101 through WAN 102 to EUD 103. In this way, EUD 103 can display, or otherwise present, the per-thread stop-the-world garbage collection management recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a per-thread stop-the-world garbage collection management recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Statically compiling program code to generate native images has become popular for applications that provide microservices. Native image is a technology to compile program code of an application to a binary (i.e., a native executable that includes only the program code needed at run time, such as the application classes, standard-library classes, the language runtime, statically-linked native code, and the like). Certain programming languages provide a static compiler to generate these native images. Unlike a just-in-time compiler, a static compiler takes more time to compile the program code to generate a native image because the static compiler runs before execution of a microservice. In contrast, the just-in-time compiler compiles the program code during execution of the microservice (i.e., at run time) rather than before execution.

Memory management using garbage collection is needed during native image runs for applications providing microservices. For example, some benchmarks show that garbage collection is heavy in certain microservice environments. Reducing garbage collection overhead will provide microservice performance gains.

Illustrative embodiments only suspend execution of application threads that read or write objects in the memory heap dedicated to the application, which provides the microservice, at the stop-the-world phase of garbage collection. In other words, illustrative embodiments allow application threads that do not perform a read or a write of objects within the memory heap to continue to run at the stop-the-world phase of garbage collection. It should be noted that illustrative embodiments can apply to any programming language that provides automatic garbage collection, such as, for example, the java programming language, go programming language, python programming language, oracle programming language, and the like.

Illustrative embodiments perform an optimization during static compilation of the application's program code so that a particular set of threads of the application, which do not read or write objects in the memory heap dedicated to the application, can continue to run even though the garbage collector requires stop-the-world in native image runs. For example, illustrative embodiments provide a new application thread state (i.e., a no-read-or-write thread state), which corresponds to a code region within the program code of the application that does not read or write objects in the memory heap dedicated to the application.

Illustrative embodiments utilize a static compiler to insert safepoints (e.g., checkpoints) into compiled program code of the application. After inserting the safepoints into the compiled program code of the application, illustrative embodiments identify any pair of contiguous safepoints corresponding to a given code region of the compiled program code. Then, illustrative embodiments determine whether the application performs any reads or writes of objects in the memory heap dedicated to the application between each pair of contiguous safepoints. If illustrative embodiments determine that the application does not perform any reads or writes of objects in the memory heap dedicated to the application between a particular pair of contiguous safepoints, then illustrative embodiments insert program code into the application to transition the state of certain threads of the application to the no-read-or-write thread state at the first safepoint of that particular pair of contiguous safepoints and also insert program code into the application to transition the state of those threads back to a normal thread state from the no-read-or-write thread state at the second safepoint of that particular pair of contiguous safepoints. Consequently, during application (i.e., microservice) runtime, even though the garbage collector requires stop-the-world, any thread of the application transitioned to the no-read-or-write thread state can continue to run between that particular pair of contiguous safepoints, thereby increasing performance. All other threads of the application that do not transition to the no-read-or-write thread state and remain in the normal thread state suspend execution between that particular pair of contiguous safepoints to prevent corruption of objects in the memory heap. The normal thread state indicates that the threads will perform reads or writes in the memory heap between that particular pair of contiguous safepoints and, therefore, need to suspend execution to prevent corruption.

It should be noted that garbage collectors, including concurrent garbage collectors, have a stop-the-world phase. In the stop-the-world phase, all application threads suspend or stop execution while the garbage collector runs. The garbage collector utilizes the stop-the-world phase to maintain data consistency (e.g., prevent data corruption) in the memory heap dedicated to the application while the garbage collector runs.

To suspend or stop execution of application threads, the static compiler, at compile time, inserts a plurality of safepoints into the program code of the application at defined locations within the program code, such as, for example, the beginning and end of method declarations, program loops, program input/outputs, and the like. During runtime of the application that provides the microservice, when the memory heap reaches a maximum capacity threshold level, the garbage collector sets a garbage collection flag. The application threads check whether the garbage collection flag is set whenever the application threads reach an inserted safepoint in the program code of the application. If the application threads determine that the garbage collection flag is set, then the application threads suspend execution at the inserted safepoint. The garbage collector, having a global view of the application threads, starts garbage collection of the memory heap when the garbage collector determines that the application threads have stopped.

However, if a set of one or more threads of the application does not read or write objects in the memory heap dedicated to the application (e.g., when a thread is performing only arithmetic calculations, performing tasks using only objects in an off-heap region of memory, performing tasks using only stack-allocated objects, and the like), then that set of threads should not need to stop execution during garbage collection because that set of threads will not cause data corruption in the memory heap during garbage collection. Consequently, that set of threads should be allowed to continue running during garbage collection when a particular code region within the program code of the application has no read or write of objects in the memory heap to increase performance.

However, it should be noted that identifying code regions of an application that do not read or write an object in the memory heap dedicated to the application is limited when utilizing just-in-time compilation. As a result, the solution when utilizing just-in-time compilation is to stop execution of all the application threads at the safepoints. In contrast to just-in-time compilation, static compilation is free from the time constraint of just-in-time compilation. Consequently, static compilation can take a longer time (e.g., hours to days) to analyze the program code of the application before execution to identify the regions in the program code that do not read or write objects in the memory heap dedicated to the application.

Thus, illustrative embodiments utilize a static compiler to identify the program code regions, which do not perform any reads or writes of objects in the memory heap dedicated to the application, located between pairs of contiguous safepoints (e.g., from safepoint #x to safepoint #x+1) inserted in the application. In addition, illustrative embodiments utilize the static compiler to apply or add a special status tag to the first safepoint (e.g., safepoint #x) of a contiguous pair of safepoints (e.g., safepoint #x and safepoint #x+1) where a program code region of the application does not perform any reads or writes of objects in the memory heap dedicated to the application. Illustrative embodiments utilize the special status tag to signal to the garbage collector that a thread transitioned to the no-read-or-write thread state does not need to suspend execution. In other words, there is no need for a thread having the no-read-or-write thread state to stop at safepoint #x having the special status tag. It should be noted that each thread of the application assigns its own state (i.e., a no-read-or-write thread state or a normal thread state) and then publishes that state to the garbage collector.

At microservice runtime, when the memory heap reaches the maximum capacity threshold level, illustrative embodiments instruct the garbage collector to set the garbage collection flag. The plurality of threads of the application providing the microservice checks whether the garbage collection flag is set when the plurality of threads reach a safepoint inserted within the program code of the application. If the plurality of threads determine that the garbage collector has set the garbage collection flag, then the plurality of threads determine whether the safepoint includes a special status tag. If the plurality of threads determine that the safepoint includes the special status tag, then a first set of threads of the plurality of threads having a normal thread state suspend their execution at the safepoint and a second set of threads of the plurality of threads having a no-read-no-write thread state continue their execution without stopping at the safepoint. The garbage collector starts garbage collection when the garbage collector determines that the first set of threads of the plurality of threads having the normal thread state suspended their execution at the safepoint and that the safepoint with the special status tag allows the second set of threads of the plurality of threads having the no-read-no-write thread state to continue their execution at the safepoint, thereby increasing performance.

Thus, illustrative embodiments provide one or more technical solutions that overcome a technical problem with a current inability to allow application threads that do not perform a read or a write of objects within a memory heap dedicated to an application to continue to run at stop-the-world garbage collection. As a result, these one or more technical solutions provide a technical effect and practical application in the field of garbage collection.

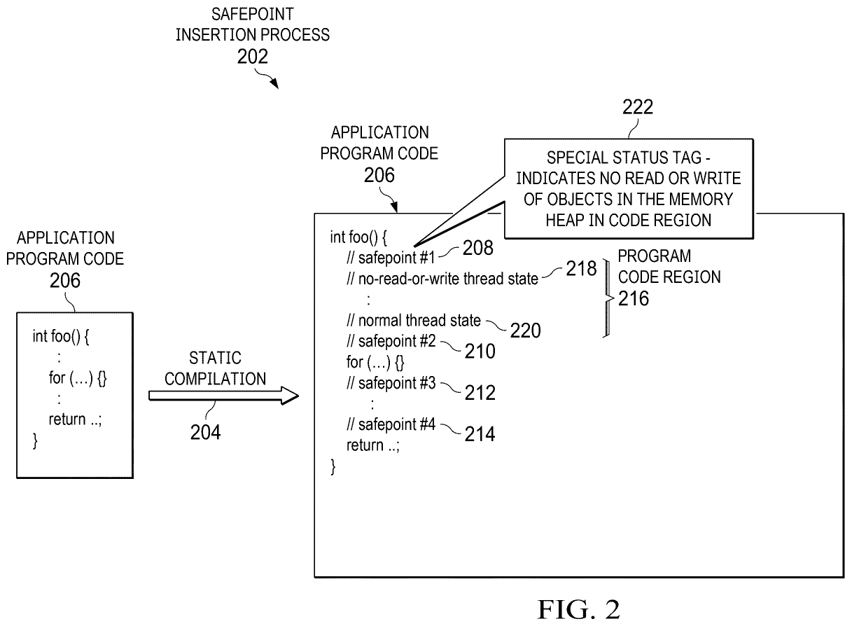

With reference now to FIG. 2, a diagram illustrating an example of a safepoint insertion process is depicted in accordance with an illustrative embodiment. Safepoint insertion process 202 is implemented in a computer, such as computer 101 in FIG. 1. For example, safepoint insertion process 202 can be implemented by per-thread stop-the-world garbage collection management code 200 in FIG. 1.

In this example at 204, the computer uses a static compiler to perform static compilation of application program code 206. Application program code 206 can be any type of application program code that is capable of garbage collection.

During static compilation of application program code 206, the static compiler inserts a plurality of safepoints in application program code 206. In this example, the plurality of safepoints includes safepoint #1 208, safepoint #2 210, safepoint #3 212, and safepoint #4 214. However, it should be noted that the static compiler can insert any number of safepoints at specified locations, such as, for example, the beginning and end of loops, input/outputs, method declarations, and the like, within application program code 206.

Further, the computer utilizes the static compiler to analyze the regions of application program code 206 between each pair of contiguous safepoints, such as safepoint #1 208 and safepoint #2 210, to determine if application program code 206 performs any reads or writes of objects in the memory heap in that particular region of application program code 206. It should be noted that safepoint #2 210 and safepoint #3 212 also represent a pair of contiguous safepoints, along with safepoint #3 212 and safepoint #4 214.

In this example, the static compiler determines application program code 206 does not perform a read or a write of an object in the memory heap in program code region 216 between the pair of contiguous safepoints comprising safepoint #1 208 and safepoint #2 210 based on the static compiler analyzing program code region 216. In response to determining that application program code 206 does not perform a read or a write of an object in the memory heap in program code region 216 between safepoint #1 208 and safepoint #2 210, the static compiler inserts code into application program code 206 at safepoint #1 208 to transition a set of one or more threads to no-read-or-write thread state 218 at safepoint #1 208 during runtime. In addition, the static compiler also inserts additional code into application program code 206 at safepoint #2 210 to transition the set of one or more threads from no-read-or-write thread state 218 to normal thread state 220 at safepoint #2 210. Furthermore, the static compiler applies special status tag 222 to safepoint #1 208 to indicate no read or write of objects in the memory heap in program code region 216 and to notify the garbage collector that the set of threads transitioned to no-read-or-write thread state 218 at safepoint #1 208 will continue to execute during stop-the-world garbage collection.

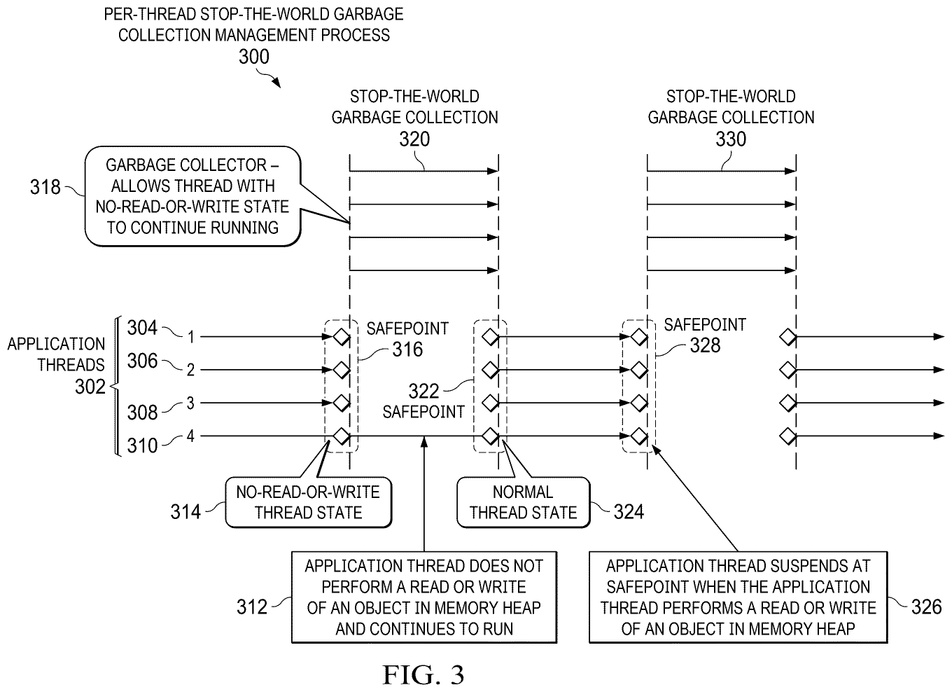

With reference now to FIG. 3, a diagram illustrating an example of a per-thread stop-the-world garbage collection management process is depicted in accordance with an illustrative embodiment. Per-thread stop-the-world garbage collection management process 300 is implemented in a computer, such as computer 101 in FIG. 1. For example, per-thread stop-the-world garbage collection management process 300 can be implemented by per-thread stop-the-world garbage collection management code 200 in FIG. 1.

In this example, per-thread stop-the-world garbage collection management process 300 includes application threads 302. Application threads 302 include application thread 1 304, application thread 2 306, application thread 3 308, and application thread 4 310. However, application threads 302 are intended as an example only and not as a limitation on illustrative embodiments. For example, application threads 302 can include more or fewer threads.

In this example, at 312, application thread 4 310 does not perform a read or write of an object in the memory heap dedicated to the application and continues to run based on application thread 4 310 transitioning to no-read-no-write thread state 314 at safepoint 316. It should be noted that application thread 1 304, application thread 2 306, and application thread 3 308 stop running at safepoint 316 because application thread 1 304, application thread 2 306, and application thread 3 308 perform reads or writes of objects in the memory heap. However, garbage collector 318 allows application thread 4 310 with no-read-no-write thread state 314 to continue to run during stop-the-world garbage collection 320 between safepoint 316 and safepoint 322.

At safepoint 322, thread 4 310 transitions from no-read-no-write thread state 314 to normal thread state 324. In addition, all of application thread 1 304, application thread 2 306, application thread 3 308, and application thread 4 310 run at safepoint 322 after completion of stop-the-world garbage collection 320. At 326, application thread 4 310 suspends at safepoint 328 during stop-the-world garbage collection 330 because application thread 4 310 now performs a read or write of an object in the memory heap based on application thread 4 310 now having normal thread state 324.

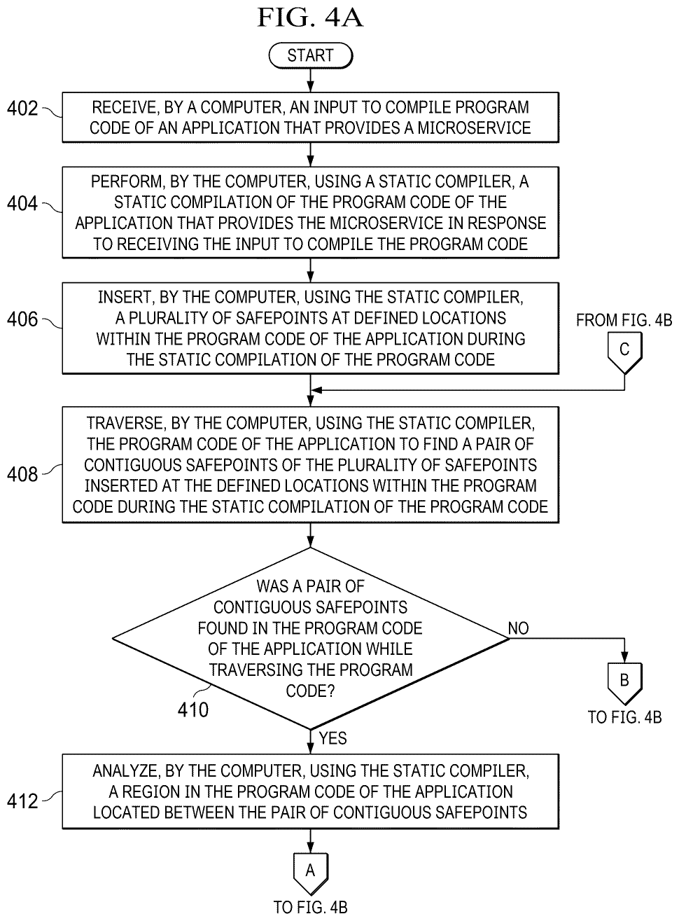

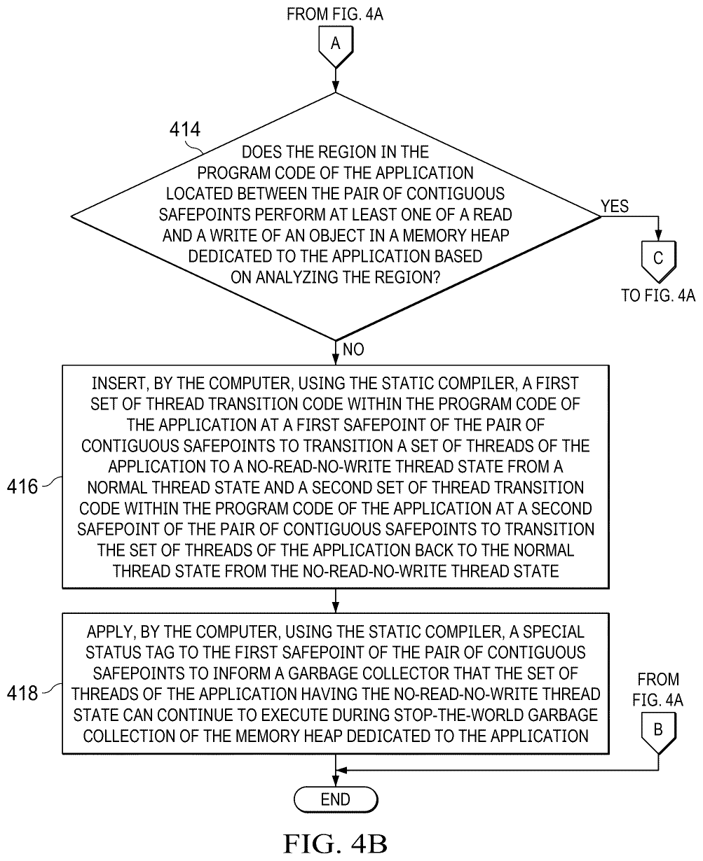

With reference now to FIGS. 4A-4B, a flowchart illustrating a process for statically compiling application program code is shown in accordance with an illustrative embodiment. The process shown in FIGS. 4A-4B may be implemented in a computer, such as, for example, computer 101 in FIG. 1. For example, the process shown in FIGS. 4A-4B may be implemented by per-thread stop-the-world garbage collection management code 200 in FIG. 1.

The process begins when the computer receives an input to compile program code of an application that provides a microservice (step 402). The computer, using a static compiler, performs a static compilation of the program code of the application that provides the microservice in response to receiving the input to compile the program code (step 404). The computer, using the static compiler, inserts a plurality of safepoints at defined locations within the program code of the application during the static compilation of the program code (step 406).

The computer, using the static compiler, traverses the program code of the application to find a pair of contiguous safepoints of the plurality of safepoints inserted at the defined locations within the program code during the static compilation of the program code (step 408). The computer makes a determination as to whether a pair of contiguous safepoints was found in the program code of the application while traversing the program code (step 410).

If the computer determines that a pair of contiguous safepoints was not found in the program code of the application while traversing the program code, no output of step 410, then the process terminates thereafter. If the computer determines that a pair of contiguous safepoints was found in the program code of the application while traversing the program code, yes output of step 410, then the computer, using the static compiler, analyzes a region in the program code of the application located between the pair of contiguous safepoints (step 412). The computer makes a determination as to whether the region in the program code of the application located between the pair of contiguous safepoints performs at least one of a read and a write of an object in a memory heap dedicated to the application based on analyzing the region (step 414).

If the computer determines that the region in the program code of the application located between the pair of contiguous safepoints does perform at least one of a read and a write of an object in the memory heap dedicated to the application based on analyzing the region, yes output of step 414, then the process returns to step 408 where the computer continues to traverse the program code of the application to find another pair of contiguous safepoints. If the computer determines that the region in the program code of the application located between the pair of contiguous safepoints does not perform at least one of a read and a write of an object in the memory heap dedicated to the application based on analyzing the region, no output of step 414, then the computer, using the static compiler, inserts a first set of thread transition code within the program code of the application at a first safepoint of the pair of contiguous safepoints to transition a set of threads of the application to a no-read-no-write thread state from a normal thread state and a second set of thread transition code within the program code of the application at a second safepoint of the pair of contiguous safepoints to transition the set of threads of the application back to the normal thread state from the no-read-no-write thread state (step 416). In addition, the computer, using the static compiler, applies a special status tag to the first safepoint of the pair of contiguous safepoints to inform a garbage collector that the set of threads of the application having the no-read-no-write thread state can continue to execute during stop-the-world garbage collection of the memory heap dedicated to the application (step 418). Thereafter, the process terminates.

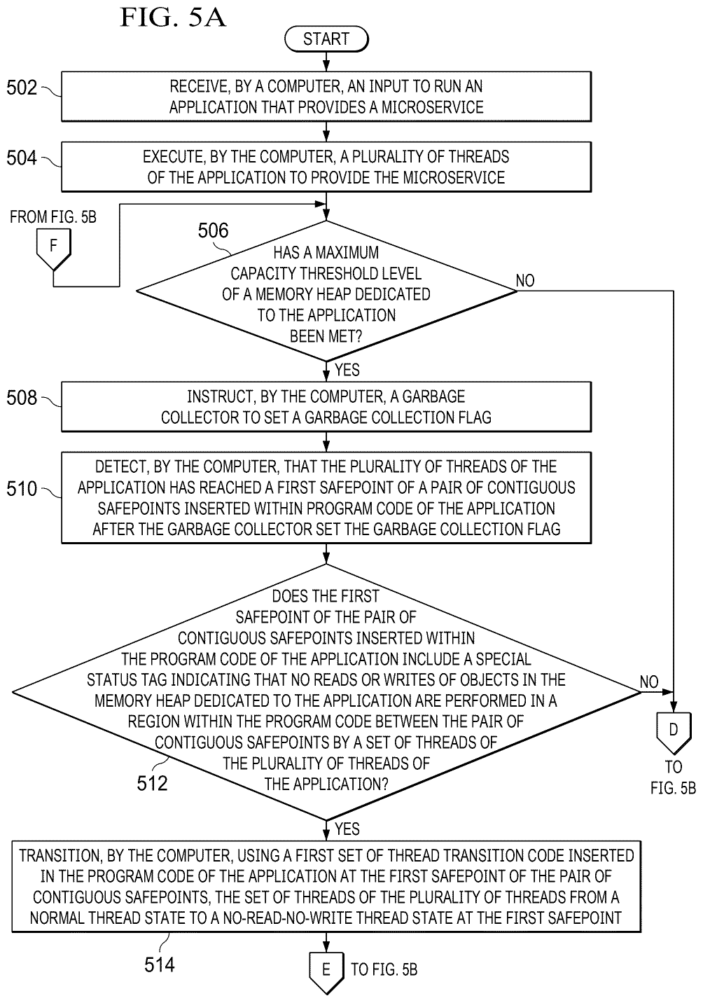

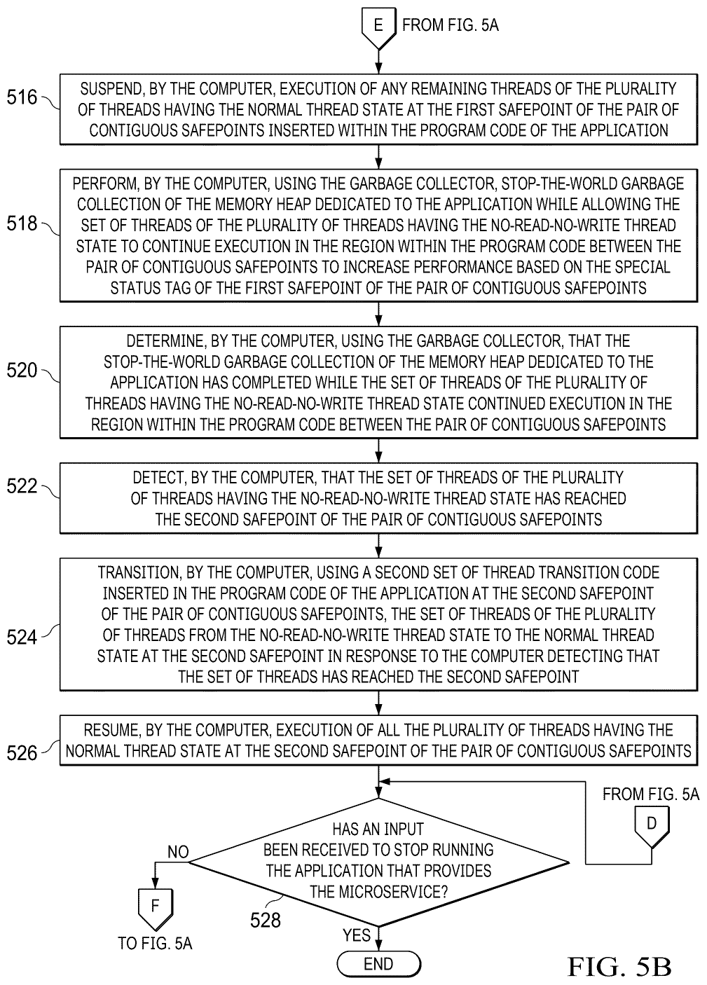

With reference now to FIGS. 5A-5B, a flowchart illustrating a process for managing per-thread stop-the-world garbage collection is shown in accordance with an illustrative embodiment. The process shown in FIGS. 5A-5B may be implemented in a computer, such as, for example, computer 101 in FIG. 1. For example, the process shown in FIGS. 5A-5B may be implemented by per-thread stop-the-world garbage collection management code 200 in FIG. 1.

The process begins when the computer receives an input to run an application that provides a microservice (step 502). The computer executes a plurality of threads of the application to provide the microservice (step 504). The computer makes a determination as to whether a maximum capacity threshold level of a memory heap dedicated to the application has been met (step 506).

If the computer determines that the maximum capacity threshold level of the memory heap dedicated to the application has not been met, no output of step 506, then the process proceeds to step 528. If the computer determines that the maximum capacity threshold level of the memory heap dedicated to the application has been met, yes output of step 506, then the computer instructs a garbage collector to set a garbage collection flag (step 508). Subsequently, the computer detects that the plurality of threads of the application has reached a first safepoint of a pair of contiguous safepoints inserted within program code of the application after the garbage collector set the garbage collection flag (step 510). The computer makes a determination as to whether the first safepoint of the pair of contiguous safepoints inserted within the program code of the application includes a special status tag indicating that no reads or writes of objects in the memory heap dedicated to the application are performed in a region within the program code between the pair of contiguous safepoints by a set of threads of the plurality of threads of the application (step 512).

If the computer determines that the first safepoint of the pair of contiguous safepoints inserted within the program code of the application does not include a special status tag indicating that no reads or writes of objects in the memory heap dedicated to the application are performed in the region within the program code between the pair of contiguous safepoints by a set of threads of the plurality of threads of the application, no output of step 512, then the process proceeds to step 528. If the computer determines that the first safepoint of the pair of contiguous safepoints inserted within the program code of the application does include the special status tag indicating that no reads or writes of objects in the memory heap dedicated to the application are performed in the region within the program code between the pair of contiguous safepoints by the set of threads of the plurality of threads of the application, yes output of step 512, then the computer, using a first set of thread transition code inserted in the program code of the application at the first safepoint of the pair of contiguous safepoints, transitions the set of threads of the plurality of threads from a normal thread state to a no-read-no-write thread state at the first safepoint (step 514).

Further, the computer suspends execution of any remaining threads of the plurality of threads having the normal thread state at the first safepoint of the pair of contiguous safepoints inserted within the program code of the application (step 516). Furthermore, the computer, using the garbage collector, performs stop-the-world garbage collection of the memory heap dedicated to the application while allowing the set of threads of the plurality of threads having the no-read-no-write thread state to continue execution in the region within the program code between the pair of contiguous safepoints to increase performance based on the special status tag of the first safepoint of the pair of contiguous safepoints (step 518).

Subsequently, the computer, using the garbage collector, determines that the stop-the-world garbage collection of the memory heap dedicated to the application has completed while the set of threads of the plurality of threads having the no-read-no-write thread state continued execution in the region within the program code between the pair of contiguous safepoints (step 520). The computer detects that the set of threads of the plurality of threads having the no-read-no-write thread state has reached the second safepoint of the pair of contiguous safepoints (step 522).

The computer, using a second set of thread transition code inserted in the program code of the application at the second safepoint of the pair of contiguous safepoints, transitions the set of threads of the plurality of threads from the no-read-no-write thread state to the normal thread state at the second safepoint in response to the computer detecting that the set of threads has reached the second safepoint (step 524). Afterward, the computer resumes execution of all the plurality of threads having the normal thread state at the second safepoint of the pair of contiguous safepoints (step 526).

The computer makes a determination as to whether an input has been received to stop running the application that provides the microservice (step 528). If the computer determines that an input has not been received to stop running the application that provides the microservice, no output of step 528, then the process returns to step 506 where the computer determines whether the maximum capacity threshold level of the memory heap dedicated to the application has been met. If the computer determines that an input has been received to stop running the application that provides the microservice, yes output of step 528, then the process terminates thereafter.

Thus, illustrative embodiments of the present disclosure provide a computer-implemented method, computer system, and computer program product for managing per-thread stop-the-world garbage collection. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing per-thread stop-the-world garbage collection, the computer-implemented method comprising:
transitioning, by a computer, using a first set of thread transition code inserted in program code of an application at a first safepoint of a pair of contiguous safepoints, a set of threads of a plurality of threads from a normal thread state to a no-read-no-write thread state at the first safepoint;
suspending, by the computer, execution of any remaining threads of the plurality of threads having a normal thread state at the first safepoint of the pair of contiguous safepoints inserted within the program code of the application; and
performing, by the computer, using a garbage collector, stop-the-world garbage collection of a memory heap dedicated to the application while allowing the set of threads of the plurality of threads having the no-read-no-write thread state to continue execution in a region within the program code between the pair of contiguous safepoints based on a special status tag of the first safepoint of the pair of contiguous safepoints.

2. The computer-implemented method of claim 1, further comprising:
determining, by the computer, using the garbage collector, that the stop-the-world garbage collection of the memory heap dedicated to the application has completed while the set of threads of the plurality of threads having the no-read-no-write thread state continued execution in the region within the program code between the pair of contiguous safepoints;
detecting, by the computer, that the set of threads of the plurality of threads having the no-read-no-write thread state has reached a second safepoint of the pair of contiguous safepoints;
transitioning, by the computer, using a second set of thread transition code inserted in the program code of the application at the second safepoint of the pair of contiguous safepoints, the set of threads of the plurality of threads from the no-read-no-write thread state to the normal thread state at the second safepoint in response to the computer detecting that the set of threads has reached the second safepoint; and
executing, by the computer, all the plurality of threads having the normal thread state at the second safepoint of the pair of contiguous safepoints.

3. The computer-implemented method of claim 1, further comprising:
executing, by the computer, the plurality of threads of the application to provide a microservice;
determining, by the computer, whether a maximum capacity threshold level of the memory heap dedicated to the application has been met; and
responsive to the computer determining that the maximum capacity threshold level of the memory heap dedicated to the application has been met, instructing, by the computer, the garbage collector to set a garbage collection flag.

4. The computer-implemented method of claim 1, further comprising:
detecting, by the computer, that the plurality of threads of the application has reached the first safepoint of the pair of contiguous safepoints inserted within the program code of the application after the garbage collector set a garbage collection flag;
determining, by the computer, whether the first safepoint of the pair of contiguous safepoints inserted within the program code of the application includes a special status tag indicating that no reads or writes of objects in the memory heap dedicated to the application are performed in the region within the program code between the pair of contiguous safepoints by the set of threads of the plurality of threads of the application; and
responsive to the computer determining that the first safepoint of the pair of contiguous safepoints inserted within the program code of the application does include the special status tag indicating that no reads or writes of objects in the memory heap dedicated to the application are performed in the region within the program code between the pair of contiguous safepoints by the set of threads of the plurality of threads of the application, transitioning, by the computer, using the first set of thread transition code inserted in the program code of the application at the first safepoint of the pair of contiguous safepoints, the set of threads of the plurality of threads from the normal thread state to the no-read-no-write thread state at the first safepoint.

5. The computer-implemented method of claim 1, further comprising:
performing, by the computer, using a static compiler, a static compilation of the program code of the application that provides a microservice in response to receiving an input to compile the program code; and
inserting, by the computer, using the static compiler, a plurality of safepoints at defined locations within the program code of the application during the static compilation of the program code.

6. The computer-implemented method of claim 1, further comprising:
traversing, by the computer, using a static compiler, the program code of the application to find the pair of contiguous safepoints of a plurality of safepoints inserted at defined locations within the program code during static compilation of the program code;
determining, by the computer, whether the pair of contiguous safepoints was found in the program code of the application while traversing the program code; and
responsive to the computer determining that the pair of contiguous safepoints was found in the program code of the application while traversing the program code, analyzing, by the computer, using the static compiler, the region in the program code of the application located between the pair of contiguous safepoints.

7. The computer-implemented method of claim 1, further comprising:
determining, by the computer, whether the region in the program code of the application located between the pair of contiguous safepoints performs at least one of a read and a write of an object in the memory heap dedicated to the application based on the computer analyzing the region utilizing a static compiler;
responsive to the computer determining that the region in the program code of the application located between the pair of contiguous safepoints does not perform at least one of a read and a write of an object in the memory heap dedicated to the application based on the computer analyzing the region, inserting, by the computer, using the static compiler, the first set of thread transition code within the program code of the application at the first safepoint of the pair of contiguous safepoints to transition the set of threads of the application to the no-read-no-write thread state from the normal thread state and a second set of thread transition code within the program code of the application at a second safepoint of the pair of contiguous safepoints to transition the set of threads of the application back to the normal thread state from the no-read-no-write thread state; and
applying, by the computer, using the static compiler, a special status tag to the first safepoint of the pair of contiguous safepoints to inform the garbage collector that the set of threads of the application having the no-read-no-write thread state can continue to execute during the stop-the-world garbage collection of the memory heap dedicated to the application.

8. A computer system for managing per-thread stop-the-world garbage collection, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
transition, using a first set of thread transition code inserted in program code of an application at a first safepoint of a pair of contiguous safepoints, a set of threads of a plurality of threads from a normal thread state to a no-read-no-write thread state at the first safepoint;
suspend execution of any remaining threads of the plurality of threads having a normal thread state at the first safepoint of the pair of contiguous safepoints inserted within the program code of the application; and
perform, using a garbage collector, stop-the-world garbage collection of a memory heap dedicated to the application while allowing the set of threads of the plurality of threads having the no-read-no-write thread state to continue execution in a region within the program code between the pair of contiguous safepoints based on a special status tag of the first safepoint of the pair of contiguous safepoints.

9. The computer system of claim 8, wherein the set of processors further executes the program instructions to:
determine, using the garbage collector, that the stop-the-world garbage collection of the memory heap dedicated to the application has completed while the set of threads of the plurality of threads having the no-read-no-write thread state continued execution in the region within the program code between the pair of contiguous safepoints;
detect that the set of threads of the plurality of threads having the no-read-no-write thread state has reached a second safepoint of the pair of contiguous safepoints;
transition, using a second set of thread transition code inserted in the program code of the application at the second safepoint of the pair of contiguous safepoints, the set of threads of the plurality of threads from the no-read-no-write thread state to the normal thread state at the second safepoint in response to the computer detecting that the set of threads has reached the second safepoint; and
execute all the plurality of threads having the normal thread state at the second safepoint of the pair of contiguous safepoints.

10. The computer system of claim 8, wherein the set of processors further executes the program instructions to:
execute the plurality of threads of the application to provide a microservice;
determine whether a maximum capacity threshold level of the memory heap dedicated to the application has been met; and
instruct the garbage collector to set a garbage collection flag in response to determining that the maximum capacity threshold level of the memory heap dedicated to the application has been met.

11. The computer system of claim 8, wherein the set of processors further executes the program instructions to:
detect that the plurality of threads of the application has reached the first safepoint of the pair of contiguous safepoints inserted within the program code of the application after the garbage collector set a garbage collection flag;
determine whether the first safepoint of the pair of contiguous safepoints inserted within the program code of the application includes a special status tag indicating that no reads or writes of objects in the memory heap dedicated to the application are performed in the region within the program code between the pair of contiguous safepoints by the set of threads of the plurality of threads of the application; and
transition, using the first set of thread transition code inserted in the program code of the application at the first safepoint of the pair of contiguous safepoints, the set of threads of the plurality of threads from the normal thread state to the no-read-no-write thread state at the first safepoint in response to determining that the first safepoint of the pair of contiguous safepoints inserted within the program code of the application does include the special status tag indicating that no reads or writes of objects in the memory heap dedicated to the application are performed in the region within the program code between the pair of contiguous safepoints by the set of threads of the plurality of threads of the application.

12. The computer system of claim 8, wherein the set of processors further executes the program instructions to:
perform, using a static compiler, a static compilation of the program code of the application that provides a microservice in response to receiving an input to compile the program code; and
insert using the static compiler, a plurality of safepoints at defined locations within the program code of the application during the static compilation of the program code.

13. The computer system of claim 8, wherein the set of processors further executes the program instructions to:
traverse, using a static compiler, the program code of the application to find the pair of contiguous safepoints of a plurality of safepoints inserted at defined locations within the program code during static compilation of the program code;
determine whether the pair of contiguous safepoints was found in the program code of the application while traversing the program code; and
analyze, using the static compiler, the region in the program code of the application located between the pair of contiguous safepoints in response to determining that the pair of contiguous safepoints was found in the program code of the application while traversing the program code.

14. A computer program product for managing per-thread stop-the-world garbage collection, the computer program product comprising a set of computer-readable storage media having program instructions collectively stored therein, the program instructions executable by a computer to cause the computer to:
transition, using a first set of thread transition code inserted in program code of an application at a first safepoint of a pair of contiguous safepoints, a set of threads of a plurality of threads from a normal thread state to a no-read-no-write thread state at the first safepoint;
suspend execution of any remaining threads of the plurality of threads having a normal thread state at the first safepoint of the pair of contiguous safepoints inserted within the program code of the application; and
perform, using a garbage collector, stop-the-world garbage collection of a memory heap dedicated to the application while allowing the set of threads of the plurality of threads having the no-read-no-write thread state to continue execution in a region within the program code between the pair of contiguous safepoints based on a special status tag of the first safepoint of the pair of contiguous safepoints.

15. The computer program product of claim 14, wherein the program instructions further cause the computer to:
determine, using the garbage collector, that the stop-the-world garbage collection of the memory heap dedicated to the application has completed while the set of threads of the plurality of threads having the no-read-no-write thread state continued execution in the region within the program code between the pair of contiguous safepoints;
detect that the set of threads of the plurality of threads having the no-read-no-write thread state has reached a second safepoint of the pair of contiguous safepoints;
transition, using a second set of thread transition code inserted in the program code of the application at the second safepoint of the pair of contiguous safepoints, the set of threads of the plurality of threads from the no-read-no-write thread state to the normal thread state at the second safepoint in response to the computer detecting that the set of threads has reached the second safepoint; and
execute all the plurality of threads having the normal thread state at the second safepoint of the pair of contiguous safepoints.

16. The computer program product of claim 14, wherein the program instructions further cause the computer to:
execute the plurality of threads of the application to provide a microservice;
determine whether a maximum capacity threshold level of the memory heap dedicated to the application has been met; and
instruct the garbage collector to set a garbage collection flag in response to determining that the maximum capacity threshold level of the memory heap dedicated to the application has been met.

17. The computer program product of claim 14, wherein the program instructions further cause the computer to:
detect that the plurality of threads of the application has reached the first safepoint of the pair of contiguous safepoints inserted within the program code of the application after the garbage collector set a garbage collection flag;
determine whether the first safepoint of the pair of contiguous safepoints inserted within the program code of the application includes a special status tag indicating that no reads or writes of objects in the memory heap dedicated to the application are performed in the region within the program code between the pair of contiguous safepoints by the set of threads of the plurality of threads of the application; and
transition, using the first set of thread transition code inserted in the program code of the application at the first safepoint of the pair of contiguous safepoints, the set of threads of the plurality of threads from the normal thread state to the no-read-no-write thread state at the first safepoint in response to determining that the first safepoint of the pair of contiguous safepoints inserted within the program code of the application does include the special status tag indicating that no reads or writes of objects in the memory heap dedicated to the application are performed in the region within the program code between the pair of contiguous safepoints by the set of threads of the plurality of threads of the application.

18. The computer program product of claim 14, wherein the program instructions further cause the computer to:
perform, using a static compiler, a static compilation of the program code of the application that provides a microservice in response to receiving an input to compile the program code; and
insert using the static compiler, a plurality of safepoints at defined locations within the program code of the application during the static compilation of the program code.

19. The computer program product of claim 14, wherein the program instructions further cause the computer to:
traverse, using a static compiler, the program code of the application to find the pair of contiguous safepoints of a plurality of safepoints inserted at defined locations within the program code during static compilation of the program code;
determine whether the pair of contiguous safepoints was found in the program code of the application while traversing the program code; and
analyze, using the static compiler, the region in the program code of the application located between the pair of contiguous safepoints in response to determining that the pair of contiguous safepoints was found in the program code of the application while traversing the program code.

20. The computer program product of claim 14, wherein the program instructions further cause the computer to:
determine whether the region in the program code of the application located between the pair of contiguous safepoints performs at least one of a read and a write of an object in the memory heap dedicated to the application based on analyzing the region utilizing a static compiler;
insert, using the static compiler, the first set of thread transition code within the program code of the application at the first safepoint of the pair of contiguous safepoints to transition the set of threads of the application to the no-read-no-write thread state from the normal thread state and a second set of thread transition code within the program code of the application at a second safepoint of the pair of contiguous safepoints to transition the set of threads of the application back to the normal thread state from the no-read-no-write thread state in response to determining that the region in the program code of the application located between the pair of contiguous safepoints does not perform at least one of a read and a write of an object in the memory heap dedicated to the application based on the computer analyzing the region; and
apply, using the static compiler, a special status tag to the first safepoint of the pair of contiguous safepoints to inform the garbage collector that the set of threads of the application having the no-read-no-write thread state can continue to execute during the stop-the-world garbage collection of the memory heap dedicated to the application.
